(19) United States
(12) Patent Application Publication
(10) Pub. No.: US 2006/0195534 A1
(43) Pub. Date: Aug. 31, 2006

(54) Information processing system, storage medium, and information processing method

(75) Inventors: Takashi Isozaki, Kanagawa (JP); Kazunaga Horiuchi, Kanagawa (JP); Hirotsugu Kashimura, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/218,834

(22) Filed: Sep. 6, 2005

(30) Foreign Application Priority Data
Feb. 28, 2005 (JP) 2005-054501

(51) Int. Cl. G06F 15/16

(52) U.S. Cl. 709/206

(57) ABSTRACT

An information processing system including: a first importance level estimation unit that employs information for emails previously received by a user to classify an email to one of a plurality of first importance level categories; and a second importance level estimation unit that employs the information for the emails previously received by the user and employs a determination reference that differs from the one used by the first importance estimation unit, to determine importance level of emails belonging to each of the first importance level categories from one of a plurality of second importance level categories, which differ from the first importance level categories, the second importance level estimation unit designating the second importance level categories in correlation with the first importance level categories, respectively. Information for the second importance level categories obtained by the second importance level estimation unit is subjected to a predetermined process.

### BACKGROUND OF THE INVENTION

1. Field of the Invention

The present invention relates to an information processing system, a storage medium, and an information processing method for processing email.

2. Description of the Related Art

Recently, since the use of email for communication has become common and an enormous number of email messages are being exchanged by users on a daily basis, there is a demand for a technique whereby important information can be extracted from the contents of a large quantity of email messages and selectively presented to users. In response to this demand, various information processing systems have been proposed for determining the importance levels of email message contents and for presenting information to users.

The following example methods have been developed: a method (see JP-A-11-154975) for determining whether email received from a predetermined address, or email in which a predetermined password is included, is important; a method (see JP-A-2000-163336) for determining an importance level in correspondence with the number of simultaneous recipients of an email message; and a method (see JP-A-2000-172580) whereby a sender can transmit an email message to which importance level information and payment period information have been added in order to update a recipient's importance level information. However, while these methods are effective in specific situations, such as when passwords are employed on both sides or when simultaneous recipients are present, importance levels cannot be determined for general users for which determination references vary.

There are other methods whereby the importance level for a newly received email message can be determined based on email previously received by an individual user. For example, the following methods have been proposed: a method (see JP-T-2002-529820) whereby the response by a user is monitored relative to previously received email, and by employing the monitoring result information, the email message is classified in accordance with a Bayesian network; and a method (see JP-T-2004-506961) whereby, based on a clear instruction received from a user or a response by a user to an email message, email is classified using Bayesian statistics or a Bayesian network or a support vector machine.

In order to apply these methods, however, when the information that is the base for a determination of the importance level changes with the passage of time, the importance level cannot be determined in consonance with such a change.

### SUMMARY OF THE INVENTION

As described above, according to the conventional examples, when, for example, a person who has sent email to a user in the same company was once a company colleague of the user, but was transferred and is no longer, the importance level of that email cannot be determined because of the time-transient change in the basic information used for determining the importance level. Nevertheless, even when the previously received email messages were received from a specific point for only a limited period, extending up the current time, they can be employed as basic information and the determination of the importance level performed by taking the current situation into consideration. However, since in this case only a limited number of email messages are available for employment as basic information, this adversely affects and deteriorates the accuracy of the determination of the importance level.

Further, when all the email messages previously received by the user are weighted in accordance with their reception dates, and the resultant email messages are employed as basic information for the determination of the importance level, the number of calculations required for the determination is increased, and the processing efficiency is deteriorated.

To resolve these problems, the present invention provides an information processing system, a storage medium, and an information processing method which provide increased efficiency for the determination of the importance level of email, while taking into account time-transient changes in the information employed as the base for the determination of email importance levels.

According to one aspect of the invention, there is provided an information processing system including: a first importance level estimation unit that employs information for emails previously received by a user to classify an email to one of a plurality of first importance level categories; and a second importance level estimation unit that employs the information for the emails previously received by the user and employs a determination reference that differs from the one used by the first importance estimation unit, to determine importance level of emails belonging to each of the first importance level categories from one of a plurality of second importance level categories, which differ from the first importance level categories, the second importance level estimation unit designating the second importance level categories in correlation with the first importance level categories, respectively; wherein information for the second importance level categories obtained by the second importance level estimation unit is subjected to a predetermined process.

According to another aspect of the invention, there is provided an information processing method performed by an information processing system, the method including: classifying an email to one of a plurality of first importance level categories while employing information for emails previously received by a user to; and determining, while employing the information for the emails previously received by the user and a determination reference that differs from the one used in the classifying, importance level of emails belonging to each of the first important level categories from one of a plurality of second importance level categories, which differ from the first importance level categories, and designating the second importance level categories in correlation with the first importance level categories, respectively; wherein information for the second importance level categories is subjected to a predetermined process.

According to still another aspect of the invention, there is provided a storage medium readable by a computer, the storage medium storing a program of instructions executable by the computer to perform a function including: classifying an email to one of a plurality of first importance level categories while employing information for emails previously received by a user to; and determining, while employing the information for the emails previously received by the user and a determination reference that differs from the one used in the classifying, importance level of emails belonging to each of the first important level categories from one of a plurality of second importance level categories, which differ from the first importance level categories, and designating the second importance level categories in correlation with the first importance level categories, respectively; wherein information for the second importance level categories is subjected to a predetermined process.

According to the present invention, the email is classified to one of the first importance level categories, and in accordance with the first importance level category, and based on a determination reference differing from the first importance level category, the email is further classified to one of the second importance level categories. With this arrangement, the importance level of email can be efficiently determined, while taking into account time-transient changes in the information that is the base for the determination of the importance level.

### BRIEF DESCRIPTION OF THE DRAWINGS

Embodiments of the present invention will be described in detail based on the following figures, wherein:

FIG. 1 is a functional block diagram showing an information processing system according to one embodiment of the present invention;

FIG. 2 is a functional block diagram showing a first importance level estimation unit of the information processing system according to the embodiment of the invention;

FIG. 3 is a functional block diagram showing a second importance level estimation unit of the information processing system according to the embodiment of the invention; and

FIG. 4 is a diagram showing example information stored in a second importance level category determination reference database of the information processing system according to the embodiment of the invention.

### DETAILED DESCRIPTION OF THE IMVENTION

An embodiment of the present invention will now be described in detail while referring to the drawings. An information processing system according to this embodiment can be constituted as an information processing apparatus, such as a portable information terminal or a server computer, or by a plurality of information processing apparatuses connected by a network.

Furthermore, the operation of the information processing system may be obtained as a software program, and this program may be provided by a computer-readable storage medium or by communication via a network, and may be performed by the information processing apparatus.

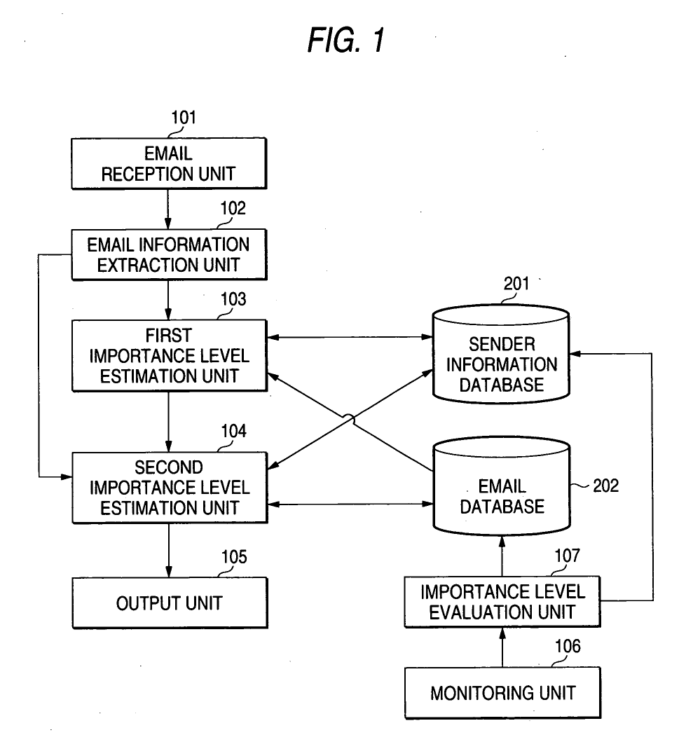

As shown in a functional block diagram in FIG. 1, the information processing system for the embodiment includes: an email reception unit 101, an email information extraction unit 102, a first importance level estimation unit 103, a second importance level estimation unit 104, an output unit 105, a monitoring unit 106, an importance level evaluation unit 107, a sender information database 201 and an email database 202. The email information extraction unit 102, the first importance level estimation unit 103, the second importance level estimation unit 104 and the importance level evaluation unit 107 can be provided, for example, by a CPU, when executing a processing program, and data stored in a storage device such as a RAM (Random Access Memory) or a ROM (Read Only Memory). The sender information database 201 and the email database 202 are prepared in a storage device such as a RAM or a hard disk drive.

The email reception unit 101, which is, for example, a network card or a modem, receives email via a network and outputs the received email to the email information extraction unit 102. The email information extraction unit 102 extracts a sender address and other information from the header of the email received from the email reception unit 101. The email information extraction unit 102 also extracts information as to whether a predetermined keyword, used to determine the importance level, is present in the main body of the email, and information relative to the number of specified characters, such as symbols that are frequently used in email advertisements, included in the main body of the email. The information extracted by the email information extraction unit 102 is employed by the first and the second importance level estimation units 103 and 104 in the preparation of an importance level estimate for the email.

The first importance level estimation unit 103 prepares an estimated importance level for the received email based on information held in the sender information database 201 and the email database 202, and the information obtained by the email information extraction unit 102. The processing performed by the first importance level estimation unit 103 will be described in detail later.

The second importance level estimation unit 104 determines the final importance level for the received email by selecting one of a plurality of second importance level categories, based on information stored in the sender information database 201 and the email database 202 and on information obtained by the email information extraction unit 102, and on information for the first importance level category provided by the first importance level estimation unit 103. The processing performed by the importance level estimation unit 104 will be described in detail later.

The output unit 105 is, for example, a display unit, a loudspeaker or a communication device connected to the network, and outputs information for the received email message along with information for the importance level category obtained by the importance level estimation unit 104. Through this processing, only important email messages can be displayed on the screen of the information processing apparatus, or email messages can be arranged and displayed, in the ascending order of their importance levels, on the display of the information processing apparatus. Further, when an email message having a high importance level is received, notification for a user can be provided by a popup display, the output of an alarm, or the transfer of the email message to a portable information terminal. The contents of the process, consonant with the importance level and the range of the importance level to be processed, may be designated by the user.

The monitoring unit 106 includes a program for recording a user operation for the information processing apparatus, and a sensor or a camera, and monitors a user response related to the received email. By recording the user operation performed by the information processing apparatus, the process performed by the user for the received email message can be monitored. Example processes performed by the user are the selection of the email message using software for processing email, the display of the email message on the screen for a predetermined period of time, the printing or the deletion of the email, or the transmission of a reply to the email or the transmission of an email message to be transferred to a third party. When one of these processes is detected, information as to the date of the performance of the process, the number of times the process was performed, the speed at which the operation was entered in the information processing apparatus, and information as to whether the pertinent process was performed with another process can also be recorded. Moreover, by using a sensor or a camera, the period during which the user remained in front of the information processing apparatus and whether or not the user uttered anything may be monitored.

The importance level evaluation unit 107 evaluates the importance level for received email based on the information obtained by the monitoring unit 106 and information specifically entered by the user. An evaluation method can be a method for determining a condition simply by employing a threshold value for a monitoring item, or a method for employing Bayesian statistics or a Bayesian network or a support vector machine. The importance level evaluation unit 107 employs the obtained evaluation results to update the information stored in the email database 202 and the sender information database 201.

Information concerning the addresses of email messages previously transmitted and received by the user is stored in the sender information database 201. Example accumulated information concerning email addresses is information for the number of email messages previously received from each address by the user, information for the number of email messages previously transmitted to each address by the user, and information for the importance level category that the importance level estimation unit 104 or the importance level estimation unit 107 determined for an email message previously transmitted from the pertinent address. Further, as for the importance level of email messages received from the pertinent address, information for the ratio of the average value, the highest frequency value or the importance level category relative to the whole may be stored. These data are employed, together with information stored in the email database 202, by the first importance level estimation unit 103 and the second importance level estimation unit 104.

The history of the email messages previously transmitted and received by the user and the information extracted from the email messages is stored in the email database 202. For the email messages, information for the importance level categories determined by the second importance level estimation unit 104 or the importance level evaluation unit 107 is also stored in the email database 202. These data are employed by the first importance level estimation unit 103 and the importance level estimation unit 104, together with information stored in the sender information database 201.

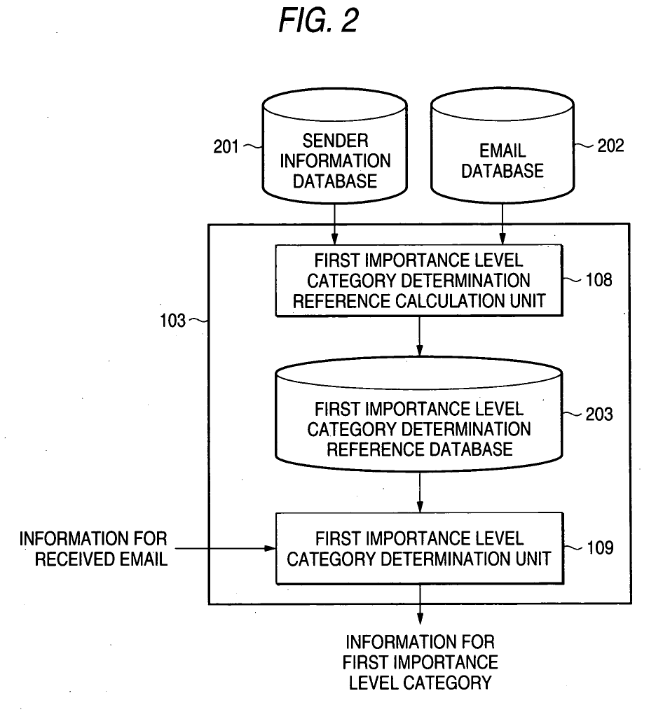

The contents of the processing performed by the first importance level estimation unit 103 will now be explained in detail. As shown in a functional block diagram in FIG. 2, the first importance level estimation unit 103 includes a first importance level category determination reference calculation unit 108, a first importance level category determination unit 109 and a first importance level category determination reference database 203. The first importance level category determination reference calculation unit 108 and the first importance level category determination unit 109 can be provided, for example, by a CPU and a processing program stored in a storage device such as a RAM or a ROM. The first importance level category determination reference database 203 is stored in a storage device such as a RAM or a hard disk drive.

The first importance level category determination reference calculation unit 108 employs information stored in the sender information database 201 and the email database 202 to determine which information is to be used as a determination reference for classifying a received email message for one of the first importance level categories. Specifically, multiple sets of determination conditions are predesignated for the contents of email messages, and the first importance level category determination reference calculation unit 108 calculates information to determine which first importance level category matches the contents of the received email message that are pertinent to one set of determination conditions. A calculation method can be a method employing Bayesian statistics or a Bayesian network, a support vector machine or a co-occurrence pattern.

When Bayesian statistics or a Bayesian network is employed, the first importance level category determination reference calculation unit 108 calculates a conditional probability whereat email that matches one specific set of determination conditions is pertinent to each of the importance level categories, and outputs the results. To perform this calculation, for previously received email messages, the importance level category determination reference calculation unit 108 employs information representing a correlation between the determination conditions and the importance level categories to which the email messages belong.

The determination conditions that are used for determining the first importance level category and that are based on the address of the sender are: the character string of the address of the sender; the number of email messages the user previously transmitted to and received from the address of the sender; and the importance level categories of the email messages previously received from the address of the sender. Especially, as for the results obtained by evaluating the importance levels of email messages previously received from the address of the sender, the ratio of the average value, the most frequent value or the importance level category thereof, relative to the whole, can be employed as the determination condition for the importance level category.

The determination conditions that are used for determining the first importance level category and that are based on the contents of received email messages are: the number of simultaneous recipients of the email; the presence/absence of an attached file; the number of characters in the main body; the number of specific characters included in the title and the main body of the email; the presence/absence of a keyword related to an importance level, such as a conference, a date, an appointment, a delivery date, an advertisement or a news item, included in the title and in the main body, and the number of times the keyword was entered; the presence/absence of salutations and polite expressions, and the types of words employed; and the results obtained by performing natural language processing for the title and the main body. Furthermore, when a file is attached to the email, the type, the size and the file name of the attached file can also be employed as determination conditions. When the email is transmitted to a recipient other than the user, information concerning the importance level category of the email the user received from the pertinent addressee can also be employed. As well as the received email, email that the user previously transmitted to the address of the sender can be employed as a determination condition.

For calculating the determination condition based on email messages previously transmitted and received, target email messages for the calculation may be limited to those received during a previous fixed period of time.

Furthermore, as a fixed determination condition, a predesignated condition can be employed without depending on the above calculation. For example, email that includes a specific keyword in its main body is always classified as belonging to the specific first importance level category.

Information indicating a correlation between a set of determination conditions that is determined by the first importance level category determination reference calculation unit 108 and the first importance level category is stored in the first importance level category determination reference database 203. The importance level category determination reference calculation unit 108 may update the first importance level category determination reference database 203 each time a new email message has been received, each time the count of the email messages received has reached a predetermined number, or each time a predetermined period of time has elapsed. The range for the updating may be the entire database 203, or may be a portion that concerns only the newly received email message.

When new email is received, the first importance level category determination unit 109 employs information extracted from the email to identify which set of determination conditions stored in the first importance level category determination reference database 203 is matched by the contents of the new email, and determines a corresponding first importance level category. The information for the determined importance level category is employed for the succeeding process performed by the second importance level estimation unit 104. Or, as described, for example, in “Expert Systems and Probabilistic Network Model”, E. Castillo, J. M. Gutierrez and A. S. Hadi, Springer-Verlag New York, Inc., 1997, a conditional probability whereby email is classified for the importance level category may be calculated by using, for example, the Baysian network probability calculation method and be stored in the first importance level category determination reference database 203, and may be employed as a propagation probability for the succeeding process performed by the second importance level estimation unit 104.

In this case, the first importance level category determination reference calculation unit 108 and a second importance level category determination reference calculation unit 110 may employ the same Baysian network.

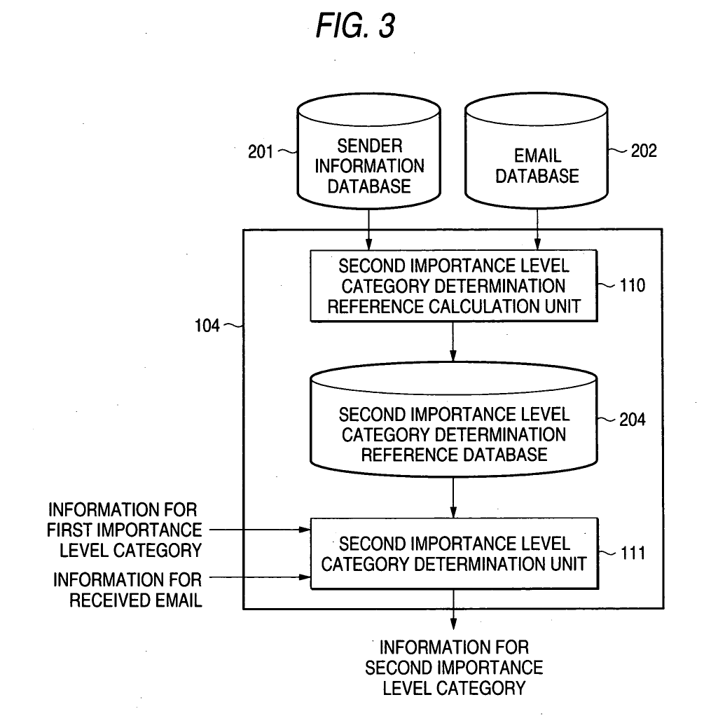

The contents of the processing performed by the second importance level estimation unit 104 will now be described. As shown in a functional block diagram in FIG. 3, the second importance level estimation unit 104 includes the second importance level category determination reference calculation unit 110, a second importance level category determination unit 111 and a second importance level category determination reference database 204. The second importance level category determination reference calculation unit 110 and the second importance level category determination unit 111 can be provided, for example, by using a CPU and a processing program stored in a storage device such as a RAM or a ROM. The second importance level category determination reference database 204 is maintained in a storage device such as a RAM or a hard disk drive.

The second importance level category determination reference calculation unit 110 employs information stored in the sender information database 201 and in the email database 202 to determine which information is to be used as a determination reference to obtain the second importance level category for email. Specifically, multiple sets of determination conditions concerning the first importance level categories and the contents of an email message are predesignated, and the second importance level category determination reference calculation unit 110 uses this information for calculations performed to determine which second importance level category matches received email pertinent to one set of determination conditions. A calculation method can be one that employs Bayesian statistics or a Bayesian network, a support vector machine or a co-occurrence pattern. When the same method as that used by the first importance level category determination reference calculation unit 108 is employed, both units can be constituted as a common program routine.

When Bayesian statistics or a Bayesian network is employed, the second importance level category determination reference calculation unit 110 calculates, as a conditional probability, which email matching a set consisting of a specific first importance level category and determination conditions is pertinent to each of the second importance level categories, and outputs the obtained results. For this calculation, the second importance level category determination reference calculation unit 110 employs information indicating a correlation between the set consisting of determination conditions and the determination results for the importance level categories of previously received email messages.

A set of antedated email messages to be used for calculating the determination reference for the second importance level category can differ from a like set to be used for calculating the determination reference for the first importance level category. For example, when email messages received during a first predetermined period of time are employed to calculate the determination reference for the first importance level category, email messages received during a second period of time that differs from the first period can be employed to calculate the determination reference for the second importance level category. The second period may be a period, part or all of which is included in the first period, or a period that does not overlap the first period. Also, a set of antedated email messages used for calculation may, instead of email messages received during a previous predetermined period, be a predetermined number of email messages received beginning with the arrival of the latest email.

As the determination condition for determining the second importance level category, the determination reference that is obtained is based on a condition, used in common by the first importance level category determination reference calculation unit 108, may be employed for a set of email messages that differ from a set of antedated email messages that is used for the determination of the first importance level category. Or determination conditions differing from those used by the first importance level category determination reference calculation unit 108 may be additionally employed.

Information concerning a correlation of multiple sets of determination conditions, which is determined by the second importance level category determination reference calculation unit 110, and the second importance level category is stored in the second importance level category determination reference database 204. The second importance level category determination reference calculation unit 110 may update the second importance level category determination reference database 204 each time a new email message has been received, each time the count of the email messages received has reached a predetermined number, or each time a predetermined period has elapsed. The range for the updating may be the entire database 204, or may be a portion that concerns only the newly received email message.

When a new email message has been received, the second importance level category determination unit 111 employs the first importance level category and information extracted from the email to identify a set of determination conditions, held in the second importance level category determination reference database 204, that the email matches, and determines a corresponding second importance level category. The information determined for the second importance level category is reflected in the sender information database 201 and the email database 202, and is employed by the output unit 105 to determine a method to be used for outputting email.

An explanation will now be given for the content of the processing performed when an email is transmitted to a user by a sender known already to the information processing system according to the embodiment of the present invention. For this processing, assume that an email message was transmitted by a person who used to be a company colleague of the user and was transferred to a different department, that the sender address is “aaa@bbbb.co.jp” and that the main body of the email includes the character string “conference”.

First, the email reception unit 101 receives the email message and transmits the contents to the email information extraction unit 102. Thereafter, the email information extraction unit 102 extracts, from the contents of the received email message, information indicating that the sender address is “aaa@bbbb.co.jp” and that the predetermined characters and keyword are included in the main body of the email message.

The first importance level estimation unit 103 then classifies email message as belonging to the first importance level category. In this case, since the sender address “aaa@bbbb.co.jp” belongs to a person who used to be a company colleague, assume that information indicating most of the email messages previously received from the pertinent sender address belong to the “high” importance level category is stored in the sender information database 201. Thus, assume that the first importance level category determination reference calculation unit 108 obtains results indicating that, most probably, the currently received email also belongs to first importance level category “high”. As a result, the first importance level category determination unit 109 determines that the first importance level category for the pertinent email is “high”, and outputs the results to the second importance level estimation unit 104.

Following this, the second importance level estimation unit 104 estimates the importance level of the email message by using the information for the first importance level category and a determination reference differing from that used by the first importance level estimation unit 103. Specifically, while the first importance level category estimation unit 103 calculates the determination reference by using information for all the email messages previously received by the user, the second importance level estimation unit 104 calculates the determination reference by employing information for email messages received during a previous predetermined period and information for the first importance level category, and determines the second importance level category for the received email message.

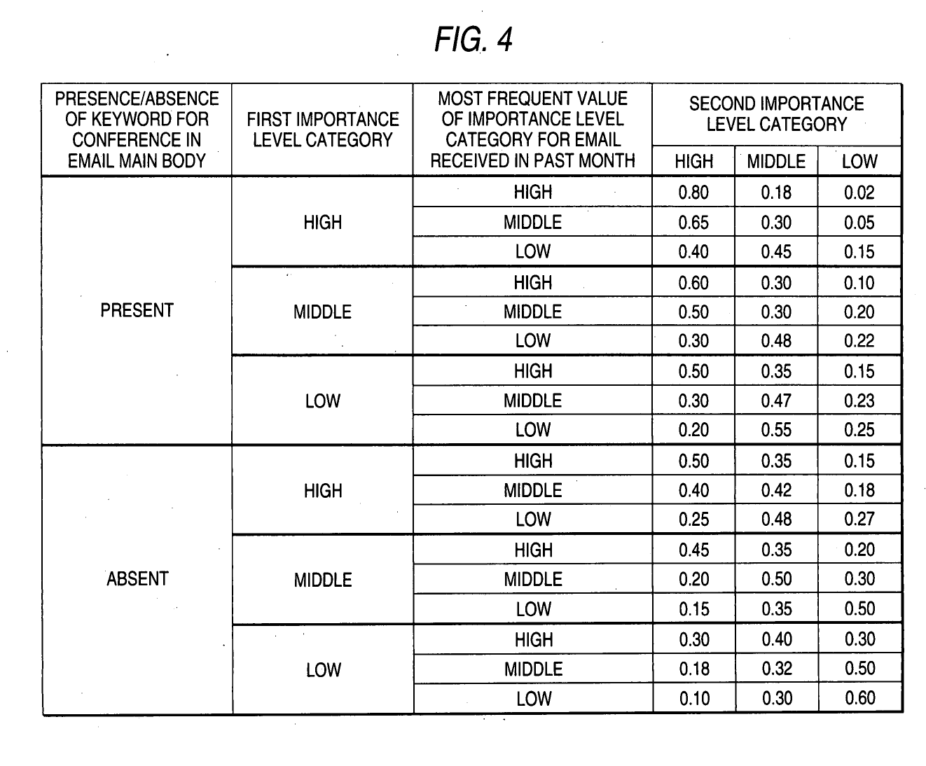

The second importance level estimation unit 104 stores, in the second importance level category determination reference database 204, the results obtained by the second importance level category determination reference calculation unit 110 based on information stored in the sender information database 201 and the email database 202. In this case, as shown in FIG. 4, for each of the second importance level categories, the probability is calculated at which a set that includes the first importance level category and the most frequent value of the importance level category of email received from a sender over the past month, and in which a keyword, extracted from the main body of email, is present/absent, will pertain to the second importance level category, and the obtained result is stored, as an example determination reference, in the second importance level category determination reference database 204. Further, assume that since the sender of the currently received email belongs to a different department from the user, email messages received from sender address “aaa@bbbb.co.jp” in the past month are mostly classified for the first importance level category “low”. Based on this information, information that the first importance level category is “high” and information that the keyword “conference” is included in the main body of the email, as shown in FIG. 4, the probability that for the received email the second importance level category is “middle” is 0.45, which is the highest. Therefore, the second importance level category determination unit 111 determines that the importance level category for this email is “middle”. This result is output to the output unit 105, and information related to the importance level of the email that is held in the sender information database 201, and the email database 202, is updated to information that reflects the determination results for the second importance level category.

Based on the thus obtained results, and in accordance with information that the importance level category for the received email is “middle”, the output unit 105 outputs information for the email.

According to the above described embodiment, when information that is the base for determination of the importance level of email is changed, due to a change in the social relationship enjoyed by a user and a sender, the importance level can be determined in accordance with that change.

In this embodiment, three levels of “high”, “middle” and “low” have been employed for the first and second importance level categories. However, more detailed category designations may be employed. Further, a user can arbitrarily designate the number of categories and the contents, or can, for example, be notified of the value of the probability belonging to “high”. Further, the user may be notified of the individual values for the probabilities “high”, “middle” and “low” obtained by weighting. In these cases, the discrete categories can be extended to continuous categories. And when probability determinations are made for multiple email messages that are then displayed at the same time, these email messages can also be sorted and displayed in the descending order of the values of the probabilities or of the values obtained by weighting the probabilities. That is, the continuous values, such as the values of probabilities belonging to specific importance level categories and the values obtained by weighting performed for probabilities belonging to the individual importance level categories, can be employed to evaluate the importance level.

Further, in this embodiment, as information stored in the second importance level category determination reference database 204, the presence/absence of a keyword concerning a conference in the main body of email and the most frequent value of the importance level category of email messages transmitted by the sender in the past month are employed. However, different determination conditions can be employed. Further, the probabilities for the importance level categories can be calculated by employing many more conditions.

The entire disclosure of Japanese Patent Application No. 2005-054501 filed on Feb. 28, 2005 including specification, claims, drawings and abstract is incorporated herein by reference in its entirety.

What is claimed is:

1. An information processing system comprising:
a first importance level estimation unit that employs information for emails previously received by a user to classify an email to one of a plurality of first importance level categories; and
a second importance level estimation unit that employs the information for the emails previously received by the user and employs a determination reference that differs from the one used by the first importance estimation unit, to determine importance level of emails belonging to each of the first importance level categories from one of a plurality of second importance level categories, which differ from the first importance level categories, the second importance level estimation unit designating the second importance level categories in correlation with the first importance level categories, respectively;
wherein information for the second importance level categories obtained by the second importance level estimation unit is subjected to a predetermined process.

2. The information processing system according to claim 1, wherein at least one of the first and second importance level estimation units employs Bayesian statistics or a Bayesian network to determine the first or the second importance level category for the email.

3. The information processing system according to claim 1, wherein the first importance level estimation unit employs information for a first set of emails as the information for the emails previously received by the user, and the second importance level estimation unit employs information for a second set of emails that differs from the first set.

4. The information processing system according to claim 1, further comprising:
a monitoring unit that monitors a response by the user relative to an email; and
an importance level evaluation unit that evaluates an importance level of the email while employing information for the response by the user obtained by the monitoring unit;
wherein the first and the second importance level estimation units determine the importance levels while employing results obtained by the importance level evaluation unit.

5. An information processing method performed by an information processing system, the method comprising:
classifying an email to one of a plurality of first importance level categories while employing information for emails previously received by a user to; and
determining, while employing the information for the emails previously received by the user and a determination reference that differs from the one used in the classifying, importance level of emails belonging to each of the first important level categories from one of a plurality of second importance level categories, which differ from the first importance level categories, and designating the second importance level categories in correlation with the first importance level categories, respectively;
wherein information for the second importance level categories is subjected to a predetermined process.

6. A storage medium readable by a computer, the storage medium storing a program of instructions executable by the computer to perform a function comprising:
classifying an email to one of a plurality of first importance level categories while employing information for emails previously received by a user to; and
determining, while employing the information for the emails previously received by the user and a determination reference that differs from the one used in the classifying, importance level of emails belonging to each of the first important level categories from one of a plurality of second importance level categories, which differ from the first importance level categories, and designating the second importance level categories in correlation with the first importance level categories, respectively;
wherein information for the second importance level categories is subjected to a predetermined process.
